(19) United States
(12) Patent Application Publication
(10) Pub. No.: US 2026/0095206 A1
(43) Pub. Date: Apr. 2, 2026

(54) NFC DEVICE DETECTION

(71) Applicant: STMicroelectronics International N.V., Geneva (CH)

(72) Inventors: Nicolas CORDIER, Aix-en-Provence (FR); Guillaume JAUNET, Pegomas (FR)

(73) Assignee: STMicroelectronics International N.V., Geneva (CH)

(21) Appl. No.: 19/335,427

(22) Filed: Sep. 22, 2025

(30) Foreign Application Priority Data
Sep. 27, 2024 (FR) FR2410388

(51) Int. Cl. H04B 5/70; H04W 4/80

(52) U.S. Cl. CPC H04B 5/70; H04W 4/80

(57) ABSTRACT

A device operating in card emulation mode detects a first near-field communication burst transmitted by an external device. The first near-field communication burst includes a first pulse having a duration Tw. The device operating in card emulation mode transmits, in response to the external device and as a result of detecting the first pulse of the first near-field communication burst, a radio frequency pulse. The radio frequency pulse has a duration shorter than or equal to the duration Tw and is transmitted within a period of time shorter than or equal to 10 μs from a leading edge of the first pulse of the first near-field communication burst.

### PRIORITY CLAIM

This application claims the priority benefit of French Application for Patent No. FR2410388, filed on Sep. 27, 2024, the content of which is hereby incorporated by reference in its entirety to the maximum extent allowable by law.

### TECHNICAL FIELD

The present disclosure generally concerns electronic devices incorporating a near-field communication (NFC) circuit and near-field communication detection methods.

### BACKGROUND

Electromagnetic transponder-based communication systems are more and more common, particularly since the development of near-field communication (NFC) technologies. These systems typically use a radio frequency electromagnetic field generated by an NFC device (terminal or reader) to detect and then communicate with another NFC device (card) located within range.

Most of the time, NFC devices are battery-powered. Periods of use of their functions and circuits are then generally interspersed with standby periods. Standby periods, in particular, enable to decrease the power consumption of NFC devices. An NFC device is then “woken up” when it detects an electronic tag or another device within range.

There exists a need for a method of “waking up” a reader device with a card device.

### SUMMARY

An embodiment provides a method comprising: detecting, by a device operating in card emulation mode, a first near-field communication burst transmitted by an external device, the first near-field communication burst comprising a first pulse having a duration Tw; and transmitting, by the device operating in card emulation mode, in response to the external device as a result of detecting the first pulse of the first burst, a radio frequency pulse having a duration shorter than or equal to the duration Tw, within a period of time shorter than or equal to 10 us from a leading edge of the first pulse.

According to an embodiment, the above method further comprises, prior to detection of the first burst: detecting, by the device operating in card emulation mode, a second near-field communication burst transmitted by the external device, the second burst comprising a first pulse; measuring, by the device operating in card emulation mode, a duration of the first pulse of the second burst; determining, by the device operating in card emulation mode, whether the measured duration of the first pulse belongs to a first reference interval; and when the measured duration belongs to the first reference interval, measuring, by the device operating in card emulation mode, a period separating the first pulse of the second near-field communication burst and the first pulse of the first near-field communication burst.

According to an embodiment, the above method further comprises: determining, by the device operating in card emulation mode, whether the measured period belongs to a second reference interval; and when the measured period belongs to the second reference interval, transmitting, by the device operating in card emulation mode, the radio frequency signal.

According to an embodiment, the second interval is an interval of 100 to 400 ms and the first interval is an interval of 40 to 60 μs.

According to an embodiment, a trailing edge of the radio frequency pulse precedes a trailing edge of the first pulse, or comes after the trailing edge of the first pulse by less than 5 μs.

According to an embodiment, the external device is in a low-power mode and the transmission of the radio frequency signal by the device operating in card emulation mode causes the leaving by the external device of the low-power mode.

According to an embodiment, the external device is a device only transmitting in reader mode.

According to an embodiment, the external device has a near-field communication transmission range shorter than or equal to 10 cm.

According to an embodiment, the radio frequency signal transmitted by the device operating in card emulation as a response to the first burst is a signal having a 13.56 MHz frequency.

According to an embodiment, the external device is an electronic lock.

An embodiment provides a near-field communication device operating in card emulation mode comprising: a field detector configured to detect a first near-field communication burst transmitted by an external device, the first near-field communication burst comprising a first pulse having a duration Tw; an antenna configured to transmit, in response to the external device as a result of the detection of the first pulse of the first near-field communication burst, a radio frequency pulse having a duration shorter than or equal to the duration Tw, within a period of time shorter than or equal to 10 us from a leading edge of the first pulse.

According to an embodiment, the device further comprises a counter configured to: measure a duration of a first pulse of a second near-field communication burst transmitted by the external device and detected by the field detector before the detection of the first burst; and when the measured duration belongs to a first reference interval, measure a period separating the first pulse of the first near-field communication burst and the first pulse of the second near-field communication burst.

An embodiment provides a system comprising: the above device operating in card emulation mode; and the external near-field communication device configured to, when it is in a low-power mode, transmit the first near-field communication burst.

According to an embodiment, the external device operates in reader mode only.

According to an embodiment, the external device is an electronic lock.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an example of a near-field communication system;

FIG. 2 shows, schematically and in the form of blocks, an example of a near-field communication circuit;

FIG. 3A is a timing diagram illustrating an example of a method of detection of a near-field communication by a device in reader mode at standby;

FIG. 3B is a timing diagram illustrating in greater detail the time of detection of a near-field communication of FIG. 3A;

FIG. 4 illustrates a method of assisting the device in reader mode by a device implemented by a device operating in card emulation mode, according to an embodiment of the present disclosure; and

FIG. 5 is a flowchart illustrating steps of the assistance method implemented by the device operating in card emulation mode, according to an embodiment of the present disclosure.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the generation of radio frequency signals and their interpretation have not been detailed, the described embodiments and implementation modes being compatible with usual techniques for generating and interpreting these signals.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

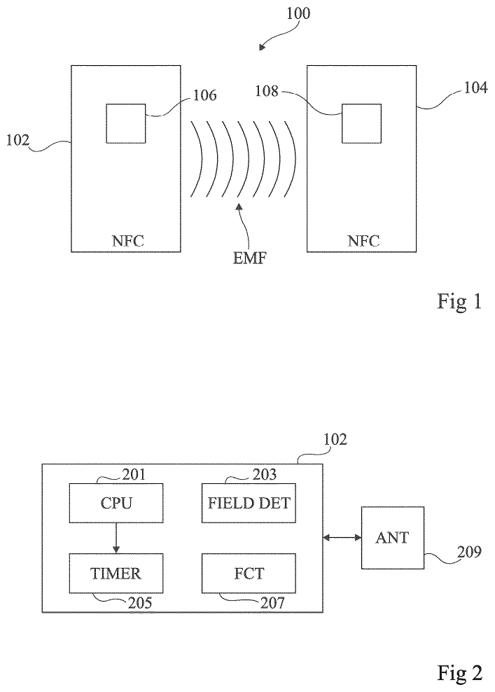

FIG. 1 shows, very schematically and in the form of blocks, an example of a near-field communication system 100 of the type to which apply, as an example, described embodiments and implementation modes.

System 100 comprises a first electronic device 102 and a second electronic device 104. Electronic devices 102 and 104 each, for example, comprise one or a plurality of near-field communication (NFC) circuits. As an example, device 102 is configured to operate in so-called card mode, corresponding to a card emulation mode, while device 104 is configured to operate in so-called reader mode.

As an example, device 102 incorporates a near-field communication circuit 106 comprising at least one electronic element or circuit for generating and detecting a radio frequency signal by means of an antenna (not shown), for example comprising modulation or demodulation circuits. As an example, device 104 incorporates a near-field communication circuit 108 comprising at least one electronic element or circuit for transmitting and detecting a radio frequency signal by means of an antenna (not shown), for example comprising modulation or demodulation circuits. During a communication from device 102 to device 104, the radio frequency signal generated by device 102 is captured by device 104 when it is within range. Device 102 transmits an electromagnetic field (EMF) captured by device 104 within range. A coupling thus forms between two oscillating circuits, in the case in point that of the antenna of device 102 and that of the antenna of device 104. This coupling results in a variation in the load formed by the circuits of device 102 on the oscillating circuit of generation of the EMF field of device 102.

In practice, to establish a communication, a variation in the phase or amplitude of the transmitted field is detected by device 102, which then initiates an NFC communication protocol with device 104. When device 102 detects the presence of device 104 in its field, it initiates a communication setup procedure implementing transmissions of requests by device 102 and of responses by device 104, for example polling sequences such as defined in the technical specifications of the NFC Forum standard.

As an example, device 102 is a device having the ability to operate in both card emulation and reader mode, such as a cell phone, a remote control, etc. Device 104 is, for example, a device which does not have the possibility of emulating a card. In an example, device 104 is an electronic lock, an access control device, etc. As an example, device 104 is configured to unlock a door, for example the door of a car, of a house, or of a locker. As an example, device 104 is integrated in a structure, for example in a door handle, in a lock, etc., powered, for example, by a battery. As an example, devices 102 and 104 form a contactless transaction system, such as a transport card validation system, a contactless payment system, etc.

Devices 102 and 104 are configured to be switched to a so-called “low power” mode, or standby mode, when they are not communicating, in order to decrease the consumed power. This is particularly the case for battery-powered NFC devices. In low-power mode, an NFC device configured in reader mode executes a so-called “Low Power Card Detection” (LPCD) mode, also known as “Low Power Tag Detection” (LPTD) mode, in which it follows loops of detection of another device located in its field (within range) in order to leave a standby mode for communication purposes. An example of a low-power mode is described in United States Patent Application Publication No. 2023/0189149 (incorporated herein by reference). As an example, both devices 102 and 104 are cell phones comprising NFC circuits configured to be switched to low-power mode.

An example of a detection in low-power mode is, for example, described in United States Patent Application Publication No. 2023/0223989 (incorporated herein by reference). In this example, the detection in low-power mode is similar to that performed when the device is not in low-power mode. However, in normal mode, the transmission of the carrier (field) is continuous and periodically includes polling frames, while, in standby mode, the transmission of the field takes place in periodic bursts with no polling frames to decrease the power consumption. The bursts have a duration significantly shorter, for example by a ratio of at least ten, preferably of at least one hundred, than the duration of a polling request in normal mode.

FIG. 2 shows, schematically and in the form of blocks, an example of embodiment of the near-field communication circuit 106 of device 102.

Near-field communication circuit 106 comprises, for example, a computing unit 201 (CPU), for example a state machine, a microcontroller, a microprocessor, a programmable logic circuit, etc. In this example, circuit 106 further comprises a field detector 203 (FIELD DET). The field detector 203 of device 102 is, for example, configured to detect an electromagnetic field radiated by device 104 when this device is located within range of device 102. As an example, the range of the electromagnetic field radiated by device 104 is in the order of several centimeters, for example shorter than or equal to 50 cm.

Near-field communication circuit 106 further comprises a counter 205 (TIMER) controlled by computing entity 201.

Circuit 102 comprises, for example, various other elements or circuits, depending on the application, for example a signal generator, analog-to-digital and/or digital-to-analog converters, modulation and/or demodulation circuits, an impedance matching circuit, a filter circuit, etc. These elements and circuits are symbolized by a single functional block 207 (FCT). Near-field communication circuit 106 further comprises, for example, one or a plurality of volatile storage areas, one or a plurality of non-volatile storage areas, one or a plurality of data, address, and control buses between the various elements internal to circuit 106, as well as one or a plurality of input/output interfaces of communication with the outside of circuit 106.

Device 102 comprises an antenna 209 (ANT) for transmitting and receiving radio frequency signals, coupled to circuit 106. Antenna 209 is, for example, configured to transmit electromagnetic field EMF. According to an embodiment, circuit 106 comprises a fast response feature enabling it to transmit a radio frequency signal rapidly, for example between 2 and 10 microseconds inclusive, after having detected a leading edge of a radio frequency pulse originating from an external device, for example device 104. In an example, this feature is implemented in hardware fashion by a state machine. In another example, this feature is implemented by computing entity 201 under the execution of software instructions. In another example, this feature is integrated in field detector 203. As an example, in low-power mode, field detector 203 consumes between 0.1 μA and 15 ρA inclusive, and its detection sensitivity is between 50 mVpp and 15 Vpp. In an example, the fast response feature is implemented by the detection of the amplitude and of the frequency of the incident signal. The duration of the detection is then in the order of one hundred microseconds. In another example, only the amplitude of the incident signal is detected, and in this case, the duration of the detection is in the order of a few microseconds, for example between 2 and 10 μs.

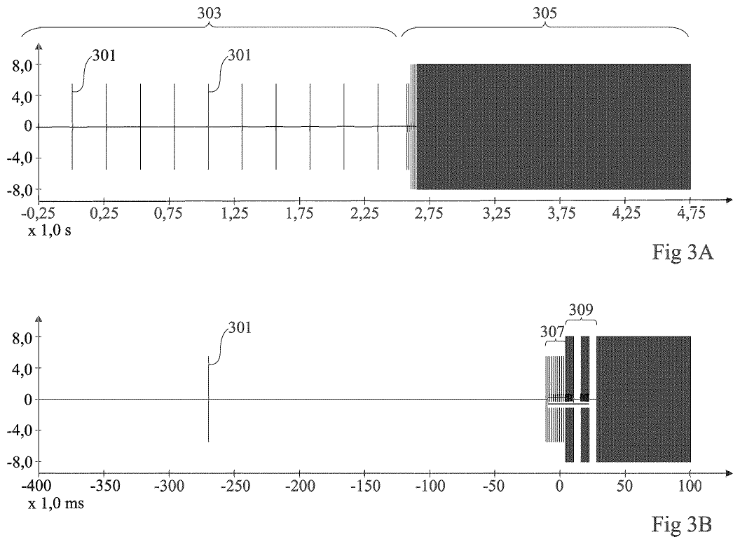

FIG. 3A is a timing diagram illustrating an example of a method of detection, by a device in reader and standby mode, for example, device 104, of a device operating in card emulation mode (i.e., where an NFC enabled device, such as a smartphone (for example), acts like a contactless card, as known to those skilled in the art), for example device 102. FIG. 3B is a timing diagram illustrating in greater detail the detection moment.

When it is in standby mode, corresponding to a period 303 in FIG. 3A, device 104, which seeks to detect the presence of device 102 within range, periodically transmits a field burst. Each field burst comprises, for example, a pulse 301 corresponding to an unmodulated carrier. The period of pulses 301, corresponding to the interval between two pulses 301, depends on devices, but is generally a few tens or hundreds of milliseconds. For example, the frequency of pulses 301 in low-power mode is in the order of a few hertz, for example in the order of 3 or 4 Hz.

The duration of a pulse 301 is, for example, in the order of tens or hundreds of microseconds, for example equal to between 20 and 100 μs inclusive, and for example between 40 and 60 μs inclusive, such as approximately 50 μs.

As an example, device 104 temporarily and periodically leaves the low-power mode to transmit bursts 301. In general, it is however preferred to use a state machine for the transmission of bursts in low-power mode. This avoids waking up a microcontroller, for example computing unit 201, of device 104, and thus enables to remain in standby mode.

If an amplitude and/or phase measurement made by device 104 exceeds a detection threshold, device 104 leaves the low-power mode and starts a detection phase 305, comprising, for example, the transmission of pulses 307 with a period decreased as compared with the period of pulses 301, and used to confirm the field detection. The detection of device 102 is possible since its charging effect on the antenna of device 104 has an impact on the amplitude and the phase of bursts 301. A procedure 309 for establishing a near-field communication is then carried out, implementing transmissions of requests and responses between devices 102 and 104, for example polling sequences such as defined in the technical specifications of the NFC Forum standard.

However, when the antenna coupled to reader device 104 has a relatively short range, for example less than 10 cm, it is difficult for device 104 to detect device 102.

A low-power mode assistance method enables device 102 to extend the detection range of device 104. Device 102 is then configured to transmit a radio frequency signal, for example at 13.56 MHz, while device 104 is transmitting in low-power mode in order to modify the electrical characteristics of device 104, and thus facilitate the detection of the presence of device 102 by device 104. However, in order to comply with the NFC Forum standard, device 104 should stop transmitting bursts in the presence of an external radio frequency signal.

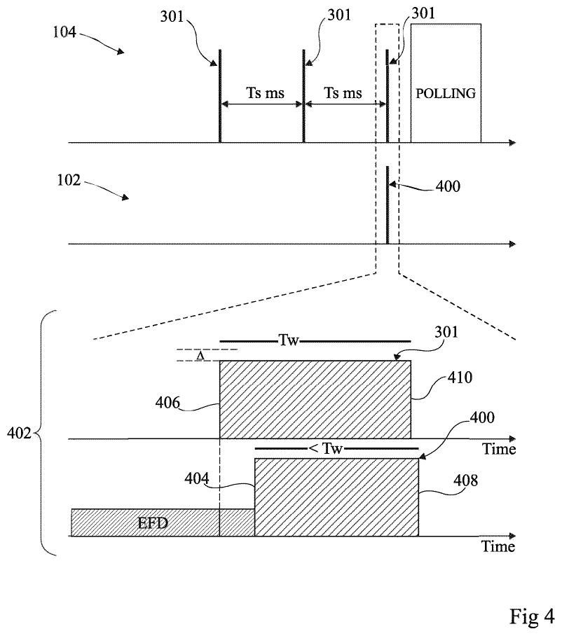

FIG. 4 illustrates a method of assisting device 104 implemented by device 102, according to an embodiment of the present disclosure.

In the shown example, reader device 104 is in low-power mode and transmits detection bursts comprising pulses 301.

Two pulses 301 of two consecutive detection bursts are separated by a duration of Ts ms, where Ts is, for example, in the range from 10 to 500 ms inclusive, and for example from 100 to 400 ms inclusive.

Each pulse 301 is transmitted for a duration of Tw μs, where Tw is, for example, in the range from 20 and 100 μs inclusive, and for example from 40 to 60 μs inclusive, such as approximately 50 μs.

Device 102 is configured to detect consecutive bursts. In particular, device 102 is configured to transmit a radio frequency signal 400, for example at 13.56 MHz, when it detects one or a plurality of bursts. According to an embodiment, device 104 implements its fast response feature (EFD). As an example, this feature is activated when device 102 is also in low-power mode.

A graph 402 of FIG. 4 is a zoom around a pulse 301 transmitted by device 102. As an example, device 102 is configured so that, as a result of the detection of a pulse 301, it transmits as a response a radio frequency signal 400 having a duration shorter than or equal to Tw ms. Signal 400 is a pulse transmitted before the end of the pulse transmitted by device 104, and having a leading edge 404 within an interval equal to or smaller than 10 μs from the leading edge 406 of the detected pulse 301. As an example, as a response to the detection of the transmission of pulse 301, pulse 400 is transmitted between 2 and 10 μs from the leading edge 406 of the detected pulse 301.

In the example of FIG. 4, a trailing edge 408 of pulse 400 comes after a trailing edge 410 of pulse 301. However, the duration of pulse 400 is selected, for example, to limit this overshoot to 5 μs after trailing edge 410. In other examples, trailing edge 408 precedes trailing edge 410. In particular, pulse 400 impacts the electrical amplitude and/or phase characteristics of pulse 301. The impact on the amplitude of pulse 301 is represented in FIG. 4 by symbol A.

The pulse 400 transmitted by device 102 enables device 104 to leave the low-power mode so as to enter, for example, a polling mode (POLLING).

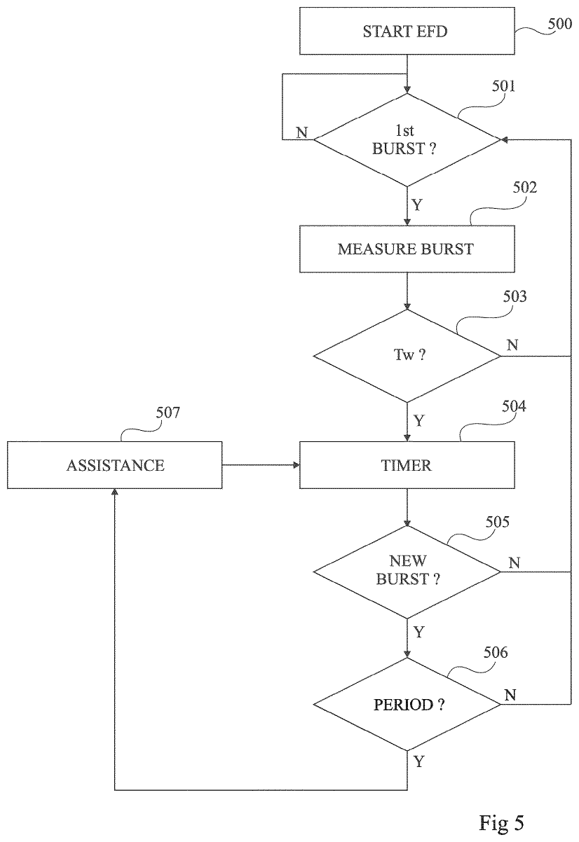

FIG. 5 is a flowchart illustrating steps of the method of assisting device 104 implemented by device 102, according to an embodiment of the present disclosure.

At a step 500 (START EFD), device 102, for example in low-power mode, activates the fast response feature.

At a step 501 (1st BURST?), following the activation of the fast response feature, device 102 is configured to detect, via field detector 203, a first burst, and in particular a first pulse 301, transmitted by an external reader device, such as for example device 104 in low-power mode.

When device 102 detects no burst (branch N at the output of block 501), the method continues in a new detection step 501.

When device 102 detects an external field (branch Y at the output of block 501), the method continues in a step 502 (MEASURE BURST). Device 102 is then configured to measure the length of the pulse 301 transmitted by device 104. As an example, the measurement of the pulse length is performed by counter 205.

When the pulse measurement has been made, the method continues in a step 503 (Tw?) in which device 102 is configured to determine whether the obtained measurement belongs to a reference interval comprising the expected duration of pulse 301. As an example, for a duration Tw of 50 μs, the reference interval is 40 and 60 μs. When the measurement of the duration of the pulse is outside the reference interval (branch N at the output of block 503), the method resumes at step 501.

When the measurement of the duration of the pulse belongs to the reference interval (branch Y at the output of block 503), the method continues in a step 504 (TIMER). During the implementation of step 504, device 102 is configured to trigger counter 205. As an example, counter 205 is triggered directly after the end of the pulse of the first burst.

As an example, at a step 505 (NEW BURST?), it is determined whether a new burst is detected by detector 203 before counter 205 reaches a threshold time period T. as an example, time T is longer than the period Ts expected between pulses 301, and is for example in the order of 500 ms. If, on expiry of the threshold time, no other burst has been detected (branch N at the output of block 505), the method resumes in a new implementation of step 502.

If a new burst is detected by field detector 203 before the expiry of the threshold time period (branch Y at the output of block 505), the method continues in step 506 (PERIOD?). During the implementation of step 506, the time period measured by counter 205 between the two bursts, corresponding to the period of the field transmitted by device 104, is compared with a reference period interval comprising period Ts. As an example, for a period Ts of 50 ms, the reference period interval lies within the interval of 100 to 400 ms. In the case where the measured period is outside the reference period interval, the method resumes in a new implementation of step 502. In the case where the measured period effectively belongs to the reference period interval, the method continues in a step 507 (ASSIST).

During the implementation of step 507, device 102 is configured to transmit a radio frequency signal rapidly, that is, before the end of the transmission of the pulse of the second burst. The transmission of this radio frequency signal is implemented, for example, via the fast response feature. As an example, the radio frequency signal transmitted by device 102 is transmitted within a time period shorter than or equal to 10 μs after the beginning of the transmission of the pulse of the new burst by the external device. As an example, the radio frequency signal is transmitted 5 μs after the detection of the leading edge of the pulse of the new burst. The duration of transmission of the radio frequency signal transmitted by device 102 is, for example, shorter than or equal to the duration Tw of transmission of the pulse of the burst transmitted by device 104.

The radio frequency signal transmitted as a response by device 102 is, for example, a signal at 13.56 MHz. As an example, the radio frequency signal transmitted as a response enables to modify the electrical characteristics of external device 104. After the implementation of step 507, the method continues in a new implementation of step 504, in which counter 205 is activated.

As an example, the method is active as soon as a card emulation mode is activated in the device. As an example, a card emulation mode is activated when a card or a digital key is added to the wallet of the device, or when the user of the device activates the near-field communication of the device.

An advantage of the described embodiments is that they enable a device operating in card emulation mode to be detected by an external device that can only transmit in reader mode.

Another advantage of the described embodiments is that they enable a device operating in card emulation mode to be detected by a reader device having a short range, for example shorter than some ten cm.

Another advantage of the described embodiments is that they enable to implement an assistance to a device in low-power reader mode while complying with the NFC Forum standard.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, regarding the hardware or software implementation of the fast response feature. Further, the described embodiments may for example apply to the case where both devices are cell phones having their near-field communication circuits configured to be switched to the low-power mode. The implementation of the described embodiments then enables to increase the detection distance between the two phones when they communicate with each other via NFC.

1. A method, comprising:
detecting, by a device operating in card emulation mode, a first near-field communication burst transmitted by an external device, the first near-field communication burst comprising a first pulse having a first duration; and
transmitting, by the device operating in card emulation mode, in response to the external device as a result of detecting the first pulse of the first near-field communication burst, a radio frequency pulse having a second duration shorter than or equal to the first duration, within a period of time shorter than or equal to 10 μs from a leading edge of the first pulse of the first near-field communication burst.

2. The method according to claim 1, further comprising, prior to detection of the first pulse of the first near-field communication burst:
detecting, by the device operating in card emulation mode, a second near-field communication burst transmitted by the external device, the second near-field communication burst comprising a first pulse;
measuring, by the device operating in card emulation mode, a third duration of the first pulse of the second near-field communication burst;
determining, by the device operating in card emulation mode, whether the measured third duration belongs to a first reference interval; and
when the measured third duration belongs to the first reference interval, measuring, by the device operating in card emulation mode, a period separating the first pulse of the second near-field communication burst and the first pulse of the first near-field communication burst.

3. The method according to claim 2, further comprising:
determining, by the device operating in card emulation mode, whether the measured period belongs to a second reference interval; and
when the measured period belongs to the second reference interval, transmitting, by the device operating in card emulation mode, the radio frequency signal.

4. The method according to claim 3, the second interval is an interval of 100 to 400 ms and the first interval is an interval of 40 to 60 μs.

5. The method according to claim 2, wherein a trailing edge of the radio frequency pulse precedes a trailing edge of the first pulse.

6. The method according to claim 2, wherein a trailing edge of the radio frequency pulse comes after the trailing edge of the first pulse by less than 5 μs.

7. The method according to claim 1, wherein the external device is in a low-power mode and wherein the transmission of the radio frequency signal by the device operating in card emulation mode causes the leaving by the external device of the low-power mode.

8. The method according to claim 1, wherein the external device is a device only transmitting in reader mode.

9. The method according to claim 1, wherein the external device has a near-field communication transmission range shorter than or equal to 10 cm.

10. The method according to claim 1, wherein the radio frequency signal transmitted by the device operating in card emulation mode as a response to the first burst is a signal having a 13.56-MHz frequency.

11. The method according to claim 1, wherein the external device is an electronic lock.

12. A near-field communication device operating in card emulation mode, comprising:
a field detector configured to detect a first near-field communication burst transmitted by an external device, the first near-field communication burst comprising a first pulse having a first duration; and
an antenna configured to transmit, in response to the external device, as a result of the detection of the first pulse of the first near-field communication burst, a radio frequency pulse having a second duration shorter than or equal to first duration, within a period of time shorter than or equal to 10 μs from a leading edge of the first pulse of the first near-field communication burst.

13. The device according to claim 12, further comprising a counter configured to:
measure a third duration of a first pulse of a second near-field communication burst transmitted by the external device and detected by the field detector prior to the detection of the first near-field communication burst; and
when the measured third duration belongs to a first reference interval, measure a period separating the first pulse of the second near-field communication burst and the first pulse of the first near-field communication burst.

14. The device according to claim 13, further configured to:
determine whether the measured period belongs to a second reference interval; and
when the measured period belongs to the second reference interval, transmit the radio frequency signal.

15. A system, comprising:
the near-field communication device operating in card emulation mode according to claim 12; and
an external near-field communication device configured to, when in a low-power mode, transmit the first near-field communication burst.

16. The system according to claim 15, wherein transmission of the radio frequency signal by the near-field communication device operating in card emulation mode causes the external near-field communication device to leave low-power mode.

17. The system according to claim 15, wherein the external device operates in reader mode only.

18. The system according to claim 17, wherein the external device is an electronic lock.
